(19) United States
(12) Patent Application Publication
(10) Pub. No.: US 2006/0187239 A1
(43) Pub. Date: Aug. 24, 2006

(54) System and method for improving visual appearance of efficient rotation algorithm

(75) Inventor: Teman D. Clark-Lindh, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/063,407

(22) Filed: Feb. 22, 2005

(51) Int. Cl. G09G 5/00

(52) U.S. Cl. 345/659

(57) ABSTRACT

A write order of a rotation/reorientation algorithm, which converts a source image to a target image with a different type orientation, is modified to reflect an order of a vertical trace at a target display. If the algorithm is triggered by the same signal as the trigger signal for a vertical blanking interval, the new write order dramatically improves the likelihood that there will be no tear effect at all. As long as the rotation/reorientation algorithm can stay ahead of the vertical trace, no visible tear effect can be seen. If the algorithm is unable to stay ahead of the vertical trace, visual quality is still improved by making the tear effects more closely resemble clean breaks than potential stair-step effects. Stair-steps are more noticeable to viewers than clean tears, resulting in an improved visual experience for the viewer.

### RELATED APPLICATIONS

This application is related by subject matter to the inventions disclosed in the following commonly assigned applications: U.S. patent application Ser. No. ______ (Atty. Docket No. MSFT-1786), entitled “SYSTEMS AND METHODS FOR UPDATING A FRAME BUFFER BASED ON ARBITRARY GRAPHICS CALLS”; and U.S. patent application Ser. No. ______ (Atty. Docket No. MSFT-1787), entitled “SYSTEMS AND METHODS FOR EFFICIENTLY DISPLAYING GRAPHICS ON A DISPLAY DEVICE REGARDLESS OF PHYSICAL ORIENTATION”.

### BACKGROUND

Computer displays are composed of a rectangular array of pixels (picture elements). The more pixels, the more detail may be shown in a given amount of space. This is termed the resolution. In order to work together, operating systems, graphics cards, and monitors support a number of standard video modes. As hardware has improved, and users have become more demanding, video modes have tended towards higher resolutions and greater color depth. As a result, a larger amount of memory is dedicated to graphics display operations on the computer motherboard and/or on the graphics card.

While a landscape mode orientation is more common among traditional computing devices such as PCs, portrait mode orientation is increasingly becoming popular in a number of proliferating devices such as Personal Digital Assistants (PDAs), cellular phones, tablet PCs, and the like.

### SUMMARY

Embodiments of the present disclosure relate to a system and method for improving visual appearance on a graphics display via an efficient rotation/reorientation algorithm. In accordance with one aspect of the present disclosure, a computer-implemented method identifies graphical hardware characteristics associated with a target display. The orientation of a source image and a target image are determined from the identified graphical hardware characteristics. After identifying a block manipulation algorithm, a new write order for the block manipulation is determined in consideration of at least one of: the identified graphical hardware characteristics, the source image orientation, the target image orientation, and the block manipulation algorithm.

In one example, the block manipulation algorithm includes reading the source image pixel-by-pixel starting at the top left corner and ending at the bottom right corner from left to right, and writing the target image pixel-by-pixel starting at the bottom left corner and ending at the top right corner from bottom to top.

In another example, the computer-implemented method determines the new write order for the block manipulation algorithm as writing the target image pixel-by-pixel starting at the top left corner and ending at the bottom right corner from left to right, when a vertical trace of a target display device scans the complete target display device from left to right.

According to yet another example, the computer-implemented method determines the new write order for the block manipulation algorithm as writing the target image pixel-by-pixel starting at the top right corner and ending at the bottom left corner from right to left, when a vertical trace of a target display device scans the complete target display device from right to left.

According to a further example, the computer-implemented method determines the new write order for the block manipulation algorithm as writing the target image pixel-by-pixel starting at the top left corner and ending at the bottom right corner from left to right in a predetermined number of horizontal bands, when a vertical trace of a target display device scans the target display device according to the predetermined number of horizontal bands from left to right.

### BRIEF DESCRIPTION OF THE DRAWINGS

FIG. 1 illustrates an example computing device that may be used in one exemplary embodiment of the present invention.

FIG. 2 illustrates a block diagram of an example computer subsystem for rendering graphics.

FIGS. 3A and 3B illustrate diagrams of rasterized patterns of pixels as drawn by two different methods on a display device in landscape-orientation.

FIG. 4 illustrates mapping of pixels from a landscape-oriented graphic display to pixels of a portrait-oriented graphic display.

FIGS. 5A, 5B, and 5C illustrate example mappings of pixels of a landscape-oriented graphic display in its original form, reoriented to a portrait-oriented display without a modified write order, and reoriented with a modified write order according to one embodiment of the present disclosure.

FIG. 6 illustrates a flowchart of an example algorithm for improving visual appearance of graphic rotation/reorientation.

### DETAILED DESCRIPTION

Embodiments of the present disclosure now will be described more fully hereinafter with reference to the accompanying drawings, which form a part hereof, and which show, by way of illustration, specific example embodiments for practicing the invention. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present disclosure may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

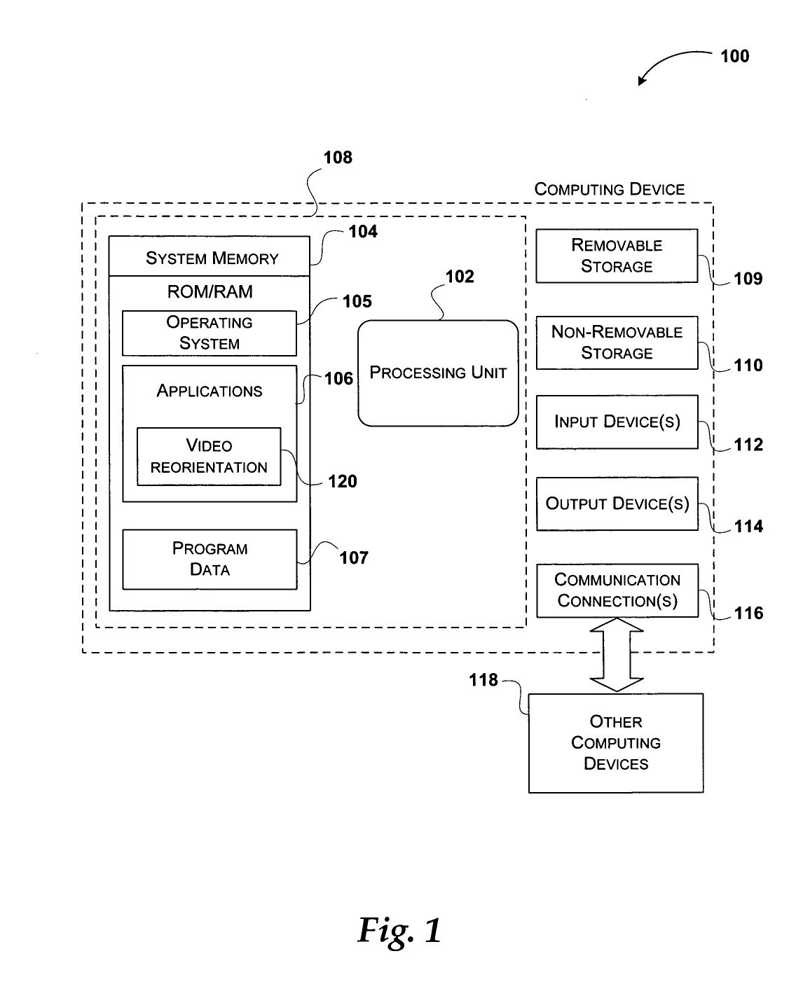

Referring to FIG. 1, an example system for implementing one aspect of the disclosure includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes an operating system 105, one or more applications 106, and may include program data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. All these devices are known in the art and need not be discussed at length here.

Computing device 100 also contains communications connection(s) 116 that allow the device to communicate with other computing devices 118, such as over a network or a wireless mesh network. Communications connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one example, applications 106 further include video reorientation application 120 for reorienting graphics from one orientation type such as landscape to another such as portrait depending on the display device type. The functionality represented by video reorientation application 120 may further be supported by additional devices such as output devices 114 and a graphics card (not shown).

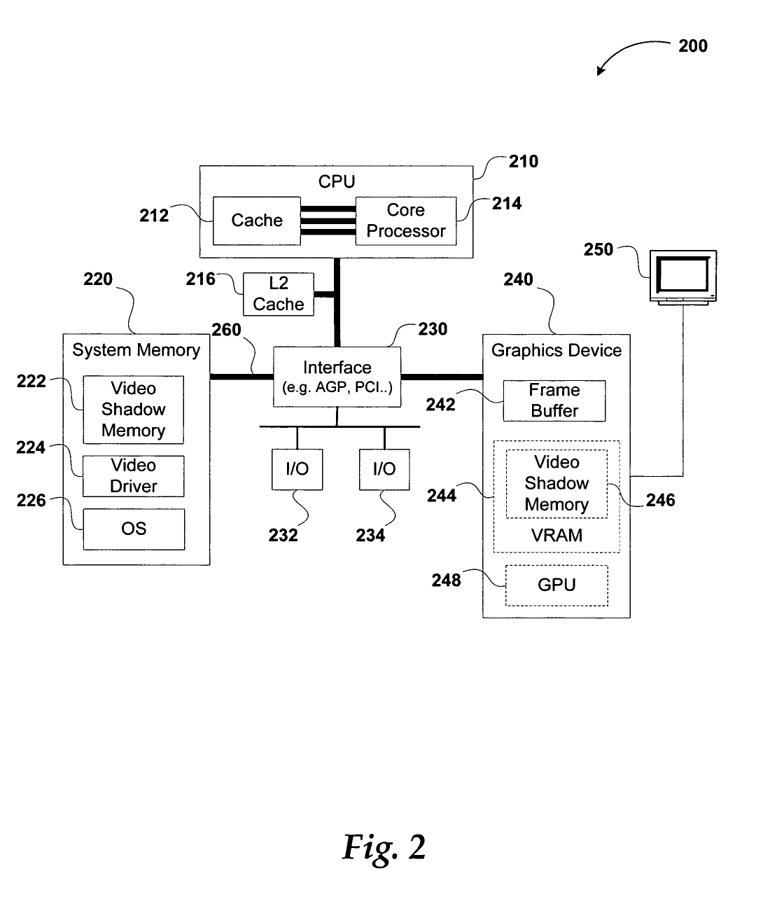

FIG. 2 illustrates a block diagram of an example computer subsystem for rendering graphics, which various embodiments of the present invention may utilize.

There are many approaches to updating graphics on a display device. According to one approach, the processor to the memory renders changes to the display graphic, and the entire updated graphics is then copied directly to the frame buffer for display. However, this method is relatively inefficient because every pixel of the display device is updated in the frame buffer whether the data for that pixel has changed or not, and the processing resources consumed by this approach may be prohibitively large.

Another approach for updating graphics on a display device utilizes a revision list to track in memory each pixel that is changed, and then copies only the updated pixels from memory to the frame buffer. This approach has the advantage of copying to the frame buffer data pertaining only to those pixels, which have changed. However, this approach is also resource intensive in regard to the memory necessary for maintaining the revision list, which may require a change to every pixel in worst case. This, along with other shortcomings, may significantly slow video processing.

In addition to updating graphics in a display device, graphics generated by software applications may have to be reoriented for different display types. For example, commonly used handheld devices such as Personal Digital Assistants (PDAs) use portrait-oriented displays, while typical Personal Computer (PC) displays are landscape-oriented. Thus, a graphics generated by an application for a PC has to be reoriented before it can be properly displayed on a PDA.

A prevalent conventional method for remapping portrait-oriented graphics rendered in system memory to the frame buffer has been to maximally leverage the benefits of write-combine (WC) cache. When present, a WC cache enables the CPU to batch together several write operations to consecutive memory addresses in the frame buffer (the target location). However, one important shortcoming that has gone largely unnoticed in the art regarding the write-combine method is that, in its quest to maximally exploit the WC cache, the write-combine method completely ignores the L2 cache, and the L2 cache becomes the bottleneck for the process of transposing portrait-oriented graphics rendered in main memory to the frame buffer. Consequently, even using the WC cache, displaying portrait-oriented graphics may be too slow and cumbersome for optimized use with devices that permit portrait oriented display utilization and/or inverted landscape orientation (such as, for example, Tablet PCs, PDAs, cellular phones).

The example graphics processing subsystem comprises a central processing unit 210 that, in turn, comprises a core processor 214 having an on-chip cache 212. In one embodiment, on-chip cache 212 may include a write-combine (WC) cache and a read cache (L1). Core processor 214 may also be directly connected to an L2 cache (216). The caching arrangement(s) of CPU 210 yields efficient access to data and instructions in random access memory (RAM 104, referring to FIG. 1). The L1 cache may be integrate in the microprocessor chip itself, in a multi-chip module, or some other arrangement. Some microprocessor chips, such as the “P6” family of chips from Intel, also include a WC cache, which enables the processor to batch together several write operations to consecutive memory addresses in order to improve performance. The optimal L2 cache may be located on a separate chip (or possibly on an expansion card) but can still be accessed more quickly than RAM, and is usually larger than the L1 cache, e.g., one megabyte is one common size for a L2 cache.

CPU 210 in the present drawing may be connected to interface 230. Interface 230 may include an accelerated graphics port (AGP), a peripheral component interconnect (PCI) bus, and the like. Interface 230 provides a point-to-point connection between the CPU 210, the system random access memory (RAM) 220, and graphics device 240, and further connects these three components to other input/output (I/O) devices 232 and 234, such as removable storage 109, non-removable storage 110, and/or other computing devices 118 of FIG. 1, via a traditional system bus such as a PCI bus 260. The presence of interface 230 also denotes that the computer system favors a system-to-video flow of data traffic, that is, that more traffic will flow from the CPU 210 and system RAM 220 to graphics device 240 than vice versa, because interface 230 is typically designed to allow up to four times as much data to flow to graphics device 240 than back from the graphics device. Graphics device 240 may include a graphics card, and external graphics device, a graphics chip, and the like.

Frame buffer 242 on graphics device 240 may be directly connected to display device 250. Frame buffer 242 may be dual-ported memory that allows a processor (graphics processing unit (GPU) 248 or CPU 210) to write a new or revised image to frame buffer 242 while display device 250 is simultaneously reading from frame buffer 242 to refresh the current display content on the display device.

In one example, the memory for frame buffer 242 is aligned to match the pixel layout of display device 250. The first pixel of this example display device corresponds to the first four bytes of frame buffer memory (four bytes being the amount of memory required for one pixel in a true color graphic). The second pixel corresponds to the second four bytes of frame buffer memory, and so on and so forth. In an example display, the first pixel of a display device is located in the upper left-hand corner of the display, the second pixel is to the right of that, and so on. The last pixel of the line is located in the upper right-hand corner of the example display and is immediately followed by the first pixel in the second row (upper left-hand corner, second pixel from the top, first pixel from the left).

The system RAM 220 may comprise operating system 226, video driver 224, and video shadow memory (VSM) 222. VSM 222, which may be a mirror image of frame buffer 242 on graphics device 240, is the location in RAM 220 where CPU 210 may construct graphic images and revisions to current graphics. CPU 210 may copy graphic images to Video RAM (VRAM) 244, Video Shadow Memory RAM 246, or frame buffer 242 from RAM 220 via interface 230. Certain example embodiments may have video rendering processes directly executed by CPU 210 and RAM 220.

The graphics device 240 may comprise a GPU 248, VRAM 244, and frame buffer 242. VRAM 244 may further comprise Video Shadow Memory RAM 246. GPU 248 and Video Shadow Memory RAM 246 are specialized components for the specific purpose of rendering video. By offloading this functionality to graphics device 240, CPU 210 and VSM 222 are freed from these tasks. However, graphics devices may lack a WC cache and an L2 cache, the former of which is deemed necessary for efficiently rendering portrait-mode graphics to a landscape-oriented frame buffer. The latter may be necessary for the reasons set forth later herein.

Therefore, while certain alternative embodiments may have video rendering directly executed by the components of graphics device 240, such execution anticipates the graphics device possessing GPU 248 with a WC cache and an L2 cache (or their equivalents). In that case the descriptions of the embodiments described herein can be readily applied to such a GPU and such alternative embodiments are fully anticipated by the disclosure herein.

Furthermore, graphics device 240 may be provided as a video card, a video chipset that is provided on a motherboard, or some other implementation. Although illustrated as an AGP device, other graphics device implementations are also contemplated such as PCI, PCI express, and others.

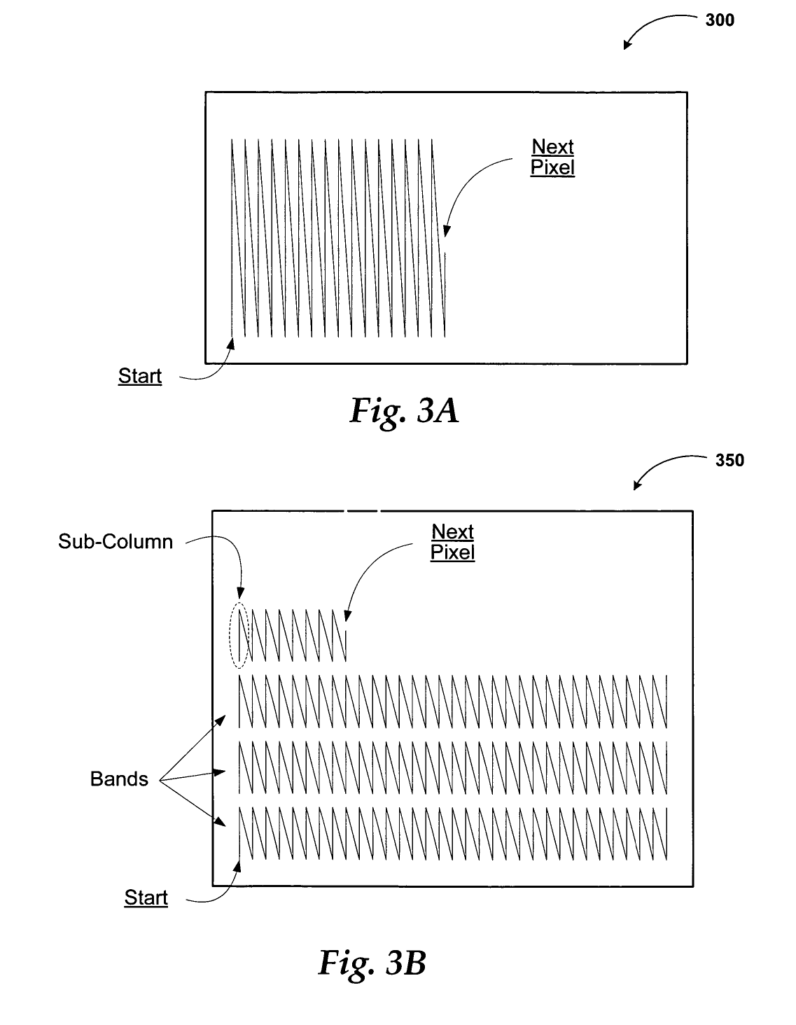

FIGS. 3A and 3B illustrate diagrams of rasterized patterns of pixels as drawn by two different methods on a display device in landscape-orientation.

The pixels may be written to a frame buffer in consecutive order that, with a large enough WC cache, could be achieved with one single write command (although one embodiment might presume a smaller WC cache, in which case more write-combine writes may be necessary). Regardless of the number of write commands, however, the example system effectively paints each pixel from left to right in rows running from top to bottom on the display device (in its native landscape orientation). FIG. 3A shows such a rasterizing pattern of a typical landscape-oriented display device (300) with the vertical trace starting at bottom-left corner.

In contrast to the line by line writing and display of pixels to the frame buffer and display device, respectively, the pixels may also be written to the frame buffer from left to right in bands to produce the graphic on the display device as horizontal bands (written pixel by pixel from bottom to top in each band running from left to right. FIG. 3B shows the rasterized pattern of the pixels as drawn on the display device in a landscape orientation (350).

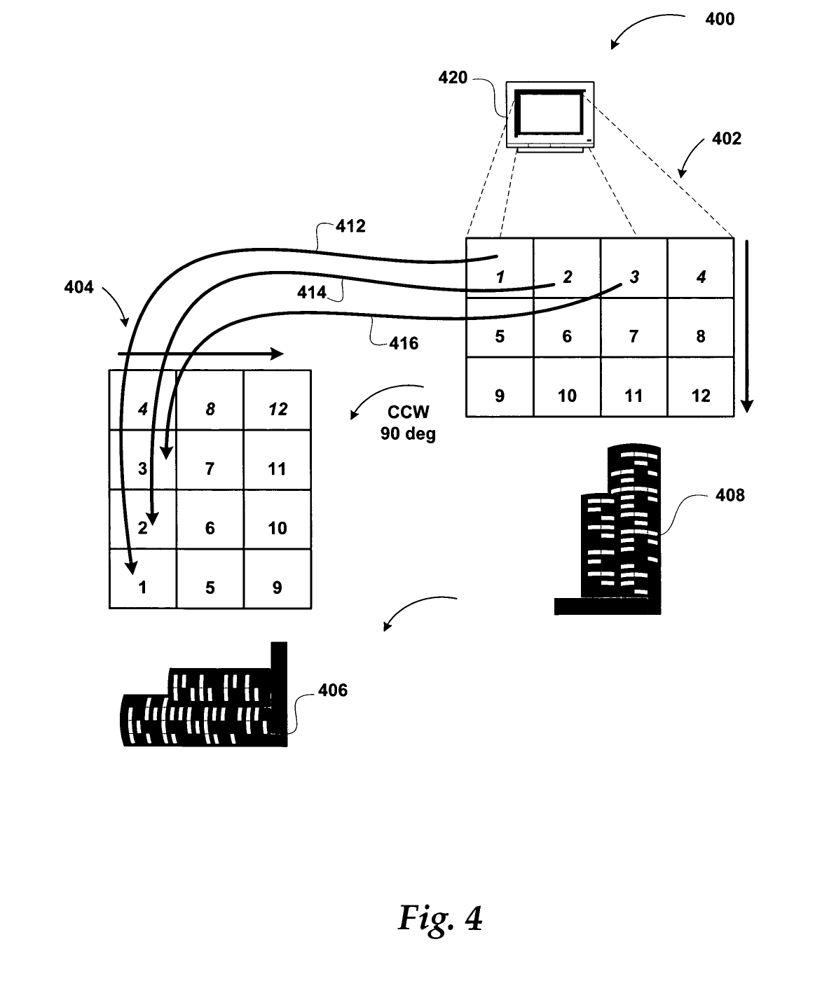

FIG. 4 illustrates mapping of a landscape-oriented full-screen graphic and its corresponding pixels to a portrait-oriented full-screen graphic and its corresponding pixels.

On some computer systems, such as a Tablet-style PC or a PDA-style device, the display has a physical orientation that can be viewed in the traditional landscape orientation, in a right-hand (primary) portrait orientation, in an inverted landscape orientation, or in a left-hand (secondary) portrait orientation. While the same can be said for any kind of computer monitor if it is physically reoriented, most monitors are not well-suited to this kind of utilization. However, such utilization is certainly anticipated by the embodiments of the present invention. In contrast to typical monitors, some computer systems, for example a Tablet PC, have physically orientable display devices to compliment and extend the usability of the computer system. For example, when a Tablet PC is docked in a base station it might be advantageous to a user to have the traditional landscape-oriented graphical display on the display device, but when reading text (for example, a virtual book) on the Tablet PC (undocked) while sitting comfortably in a chair, it might be advantageous for the user to have a portrait-oriented graphical display on the display device.

In regard to a physical portrait orientation of the display device, however, it is important to note that changing the physical orientation of a display device itself (e.g., turning it on its side) in no way changes the operation of the display device or the frame buffer. Vertical retrace and horizontal retrace directions and rates typically remain the same. So, reorienting the image on the display device to correspond with the physical orientation must also be done. There are many rotation/reorientation algorithms for achieving this task efficiently.

In a typical rotation method such as the approach described in U.S. patent application Ser. No. ______ (Atty. Docket No. MSFT-1787), titled “SYSTEMS AND METHODS FOR EFFICIENTLY DISPLAYING GRAPHICS ON A DISPLAY DEVICE REGARDLESS OF PHYSICAL ORIENTATION”, a source graphic is divided into zones comprising a predetermined number of pixels and the zones are copied along two orthogonal axes (e.g. from left to right and top to bottom) with respect to the source graphic.

At a target display, a vertical trace may be scanned top to bottom at a predetermined frequency such as 60 Hz. Accordingly, once the vertical trace passes a first row of zones, changes to the row may not be seen for another 1/60th of a second. This may lead to a highly visible tearing effect on the display device as described below in more detail.

According to one aspect, a write order of the rotation/reorientation algorithm that converts the source graphic to the target graphic is modified to reflect the order of the vertical trace of the target display. If the algorithm is triggered by the same signal as the trigger signal for the vertical blanking interval, then the reorientation algorithm dramatically improves the likelihood that there will be no tearing at all. In other words, as long as the rotation/reorientation algorithm can stay ahead of the vertical trace, no visible tearing effect can be seen.

If the algorithm is not able to stay ahead of the vertical trace, visual quality is still improved by making the tears more closely resemble clean breaks than potential stair-step effects. Stair-steps are more noticeable to viewers than clean tears, resulting in an improved visual experience for the viewer.

As illustrated in FIG. 4, memory map 402 of image 408 on landscape-oriented display device 420 comprises 12 predetermined zones. Each zone represents a predetermined number of pixels. For example, display device 420 may be a 1024×768 display device with each zone corresponding to 256×256 pixels. Following convention the zones of source memory map 402 are ordered from top left corner to bottom right corner.

To avoid stair-step shaped tear effects during reorientation of the image to target memory map 404 a write order of the zones into target memory map 404 is modified. The modified order reflects a scan order associated with the target display's vertical scan. In this example, the target display's vertical scan is from bottom left corner to top right corner. Accordingly, memory map conversion begins with copying zone 1 from top left corner of source memory map 402 to bottom left corner of target memory map 404 as indicated by remapping step 412. At remapping step 414, zone 2 is copied from source memory map 402 to a location above zone 1 in target memory map 404 within the same column. Remapping step 416 shows the copying of zone 3 following a similar pattern.

The modified write order enables rotation of the image from landscape-orientation to portrait-orientation without generating stair-step tear effects, because the vertical trace of the target display follows the same order as the updating of the individual zones. Thus, so long as the rotation/reorientation algorithm can stay ahead of the vertical trace, memory map 404 will always be updated completely.

On the other hand, if the algorithm should fall behind the vertical trace for any reason, the boundary between the updated portion of the image map and the yet unchanged portion remains a line and not a stair-step shape. Because clean breaks such as lines are more optically pleasing to viewers than stair-step shaped tears, the visual effect of the rotation is still improved using the write order modification.

By logically remapping the pixels in the memory, as shown for image map 404 in FIG. 4, the entire image 406 will be correctly copied to the target display device.

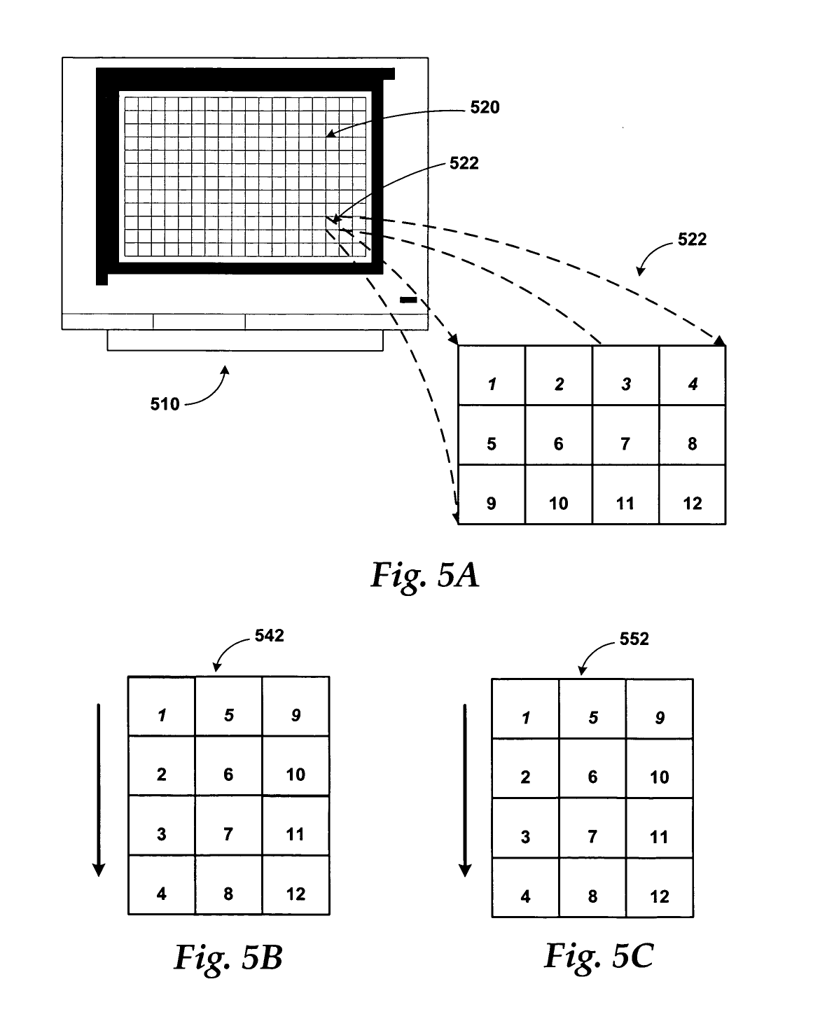

FIGS. 5A, 5B, and 5C illustrate example mappings of pixels of a landscape-oriented graphic display in its original form, reoriented to a portrait-oriented display without a modified write order, and reoriented with a modified write order.

FIG. 5A illustrates the mapping of landscape-oriented display 520 of monitor 510. Display 520 is divided into blocks, and each block may include a plurality of zones or pixels. In the example shown in FIG. 5A, block 522 is illustrated in detail. Individual zones of block 522 may be numbered from top left corner to bottom right corner indicating a direction of a vertical trace of the monitor 510. As described previously, the mapping may be stored in a cache memory, in a system VRAM, in a graphic device Video Shadow Memory RAM, and the like.

FIG. 5B illustrates the mapping of block 542, which may be part of an image shown on display 520. Block 542 may be obtained employing an efficient rotation/reorientation algorithm without the use of a modified write order according to one embodiment of the present invention. As the figure shows, block 542 represents a portrait orientation. Individual zones of block 522 are copied (and rotated) to block 542 from left to right, top to bottom with respect to the source image in this example, resulting in a copy order in sequence from 1 through 12.

In this example, the vertical trace of the target display runs top to bottom. Accordingly, once the vertical trace passes the first row, even if that data has been changed, the change may not be visible until 1/60^{th} of a second later. This may result in a stair-step effect as seen in block 542. When the vertical trace passes through the first row of the target, only zones 1-4 have been filled. When the vertical trace passes through the second row, only zones 5-9 have been filled. After the third row, the entire target display has been updated. Thus a stair-step shaped tear may occur along the edges of zones 1, 6, and 11. Optically, stair-step tears are more visible to viewers than other types.

FIG. 5C illustrates the mapping of block 552, which may be part of the image shown on display 520. Block 552 may be obtained employing the efficient rotation/reorientation algorithm using a modified write order according to one embodiment of the present invention The new write order modifies the mapping of the reoriented zones to reflect the order of the target display vertical trace. Accordingly, the target display map is filled in the order of: 1, 5, 9, 2, 6, 10, 3, 7, 11, 4, 8, and 12. As long as the rotation/reorientation algorithm can stay ahead of the vertical trace, no visible tearing effect can be seen.

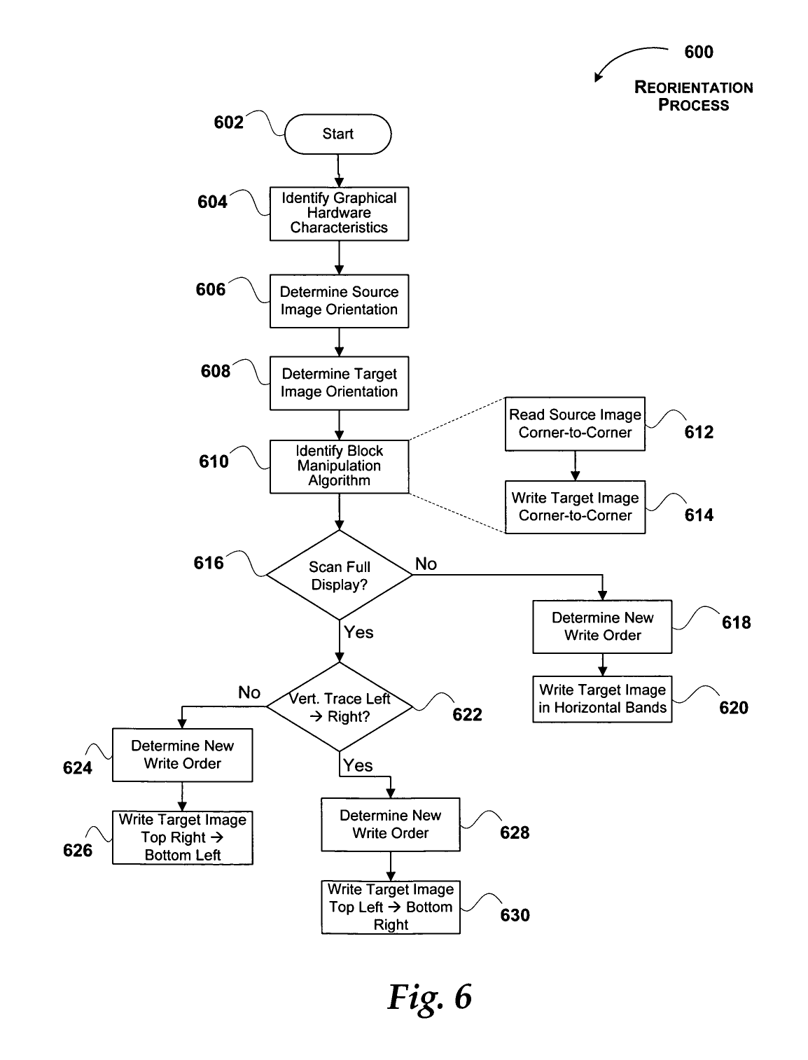

FIG. 6 illustrates a flowchart of process 600 for improving visual appearance of graphic rotation/reorientation algorithm according to one example embodiment.

Process 600 starts at block 602, when a source image is to be rotated/reoriented to a target image due to a difference in the orientation of source and target display devices. At following block 604, graphical hardware characteristics are identified. Graphical hardware characteristics may include a resolution, a horizontal and vertical retrace direction, a retrace rate, and the like, associated with the source and the target display devices. The resolution of the display device provides pixel information that may be used in determining blocks or zones for rotation/reorientation of the image. The scan type provides information about the vertical trace. Based on the vertical trace, the target image may be written to the complete display or in horizontal bands covering the target display device. Processing proceeds next to block 606.

At block 606, an orientation of the source image is determined. For example, many applications written for PCs are designed to provide landscape-orientation for typical displays. On the other hand, many handheld devices such as cellular phones and PDAs often have a portrait-oriented display.

At following block 608, the target image orientation is determined such as that of a cellular phone or PDA as mentioned above. The invention is not limited to these examples, however. Other types of display systems with any orientation type may be used to implement the aspects of the present invention described herein. Processing advances from block 608 to block 610.

At block 610, the block manipulation algorithm is determined that will be used to reorient the source image. An example a block algorithm includes the steps of reading the source image from one corner to another (block 612) and then writing the target image corner-to-corner (block 614). As described previously, various manipulation algorithms may be employed for efficient rotation/reorientation of the source image to a target image with different orientation. Processing moves from block 610 to decision block 616.

At decision block 616, a determination is made whether the full target display is scanned in one step. As described previously in conjunction with FIG. 2, source image information may be read and stored in a cache memory. Depending on the cache memory size and the vertical trace type, the whole target image may be written with one write command, or with multiple commands. One way of breaking up the target image into subsections is using a predetermined number of horizontal or vertical bands, which are scanned corner-to-corner. If the decision at block 616 is negative, processing proceeds to block 618. Otherwise, processing continues to block 622.

At block 618, a new write order for the identified block manipulation algorithm is determined. Details of the new write order for the block manipulation algorithm are discussed above in conjunction with FIGS. 4 and 5. The new write order generally tries to match a scan order of the vertical trace of the target display device. Processing then moves to block 620, where the target image information is written to a memory location in horizontal bands. Each band is treated like an individual display and once one band is completed, the next band is started in a similar fashion.

At decision block 622, a determination is made whether the vertical trace scans the target display device from left to right. If the decision is negative, processing moves to block 624. Otherwise, processing continues to block 628.

At block 624, a new write order for the block manipulation algorithm is determined similarly to the action at block 618. Processing then proceeds to block 626, where the target image is written along two orthogonal axes (e.g. from top right to bottom left) following the order of the vertical trace.

At block 628, a new write order for the block manipulation algorithm is determined similarly to the action at block 618. Processing then proceeds to block 630, where the target image is written along the two axes in opposite direction (e.g. from top left to bottom right) following the order of the vertical trace.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for ordering operations for graphical hardware characteristics, comprising:
identifying the graphical hardware characteristics;
determining a source image orientation;
determining a target image orientation;
identifying a block manipulation algorithm; and
evaluating at least one of the identified graphical hardware characteristics, the source image orientation, the target image orientation, and the block manipulation algorithm to determine a new write order for the block manipulation algorithm.

2. The computer-implemented method of claim 1, wherein the block manipulation algorithm comprises:
reading the source image pixel-by-pixel starting at a first predetermined location ending at a second predetermined location; and
writing the target image pixel-by-pixel starting at a third predetermined location ending at a fourth predetermined location.

3. The computer-implemented method of claim 2, wherein the new write order for the block manipulation algorithm comprises:
writing the target image pixel-by-pixel starting at the third predetermined location ending at the fourth predetermined location following a direction of a vertical trace of a target display.

4. The computer-implemented method of claim 3, wherein the new write order for the block manipulation algorithm significantly reduces a tear effect in the target image.

5. The computer-implemented method of claim 2, wherein the new write order for the block manipulation algorithm comprises:
if a vertical trace of a target display device scans the target display device in a predetermined number of horizontal bands from left to right, writing the target image pixel-by-pixel starting at top left corner ending at bottom right corner from left to right in the predetermined number of horizontal bands, wherein each horizontal band represents a group f pixels that correspond to a height of a predetermined block.

6. The computer-implemented method of claim 2, wherein the new write order for the block manipulation algorithm comprises:
if a vertical trace of a target display device scans the complete target display device from right to left, writing the target image pixel-by-pixel starting at top right corner ending at bottom left corner from right to left.

7. The computer-implemented method of claim 1, wherein the steps are performed by at least one of: a graphical processing unit using a video random access memory and a central processing unit using a system random access memory.

8. The computer-implemented method of claim 1, wherein the step of writing the target image pixel-by-pixel is performed by a central processing unit writing the pixels from a system random access memory directly to a frame buffer.

9. The computer-implemented method of claim 1, wherein source image orientation and the target image orientation include at least one of: a portrait mode orientation and a landscape mode orientation.

10. A computer-readable medium that includes computer-executable instructions for ordering operations for graphical hardware characteristics, the instructions comprising:
identifying the graphical hardware characteristics;
determining a source image orientation;
determining a target image orientation;
identifying a block manipulation algorithm; and
evaluating at least one of the identified graphical hardware characteristics, the source image orientation, the target image orientation, and the block manipulation algorithm to determine a new write order for the block manipulation algorithm.

11. The computer-readable medium of claim 11, wherein the new write order for the block manipulation algorithm comprises:
if a vertical trace of a target display device scans the complete target display device from left to right, writing the target image pixel-by-pixel starting at top left corner ending at bottom right corner from left to right;
if a vertical trace of a target display device scans the complete target display device from right to left, writing the target image pixel-by-pixel starting at top right corner ending at bottom left corner from right to left; and
if a vertical trace of a target display device scans the target display device in a predetermined number of horizontal bands from left to right, writing the target image pixel-by-pixel starting at top left corner ending at bottom right corner from left to right in the predetermined number of horizontal bands.

12. The computer-readable medium of claim 10, wherein the computer-executable instructions are performed by at least one of: a graphical processing unit using a video random access memory and a central processing unit using a system random access memory.

13. A system for ordering operations for converting a graphic of a first type orientation to a graphic of a second type orientation, comprising:
a processor arranged to perform actions including:
identifying the first type orientation and the second type orientation;
identifying a block manipulation algorithm;
determining a new write order for the block manipulation algorithm;
reading the graphic of the first type orientation pixel-by-pixel starting at a first predetermined location ending at a second predetermined location in an orthogonal order; and
writing the graphic of the second type orientation pixel-by-pixel starting at a third predetermined location ending at a fourth predetermined location in another orthogonal order; and
a first memory location, coupled to the processor, that is arranged to store the graphic of the first type orientation; and
a second memory location, coupled to the processor, that is arranged to store the graphic of the second type orientation.

14. The system of claim 13, wherein the first type orientation and the second type orientation include one of a portrait orientation and a landscape orientation.

15. The system of claim 13, wherein the processor is at least one of: a central processing unit (CPU) and a graphical processing unit (GPU).

16. The system of claim 15, wherein the GPU resides on a graphics card.

17. The system of claim 13, wherein the first memory location and the second memory location reside in at least one of: a system random access memory and a video random access memory.

18. The system of claim 17, the first memory location and the second memory location reside in a video shadow memory within at least one of: the system random access memory and the video random access memory.

19. The system of claim 13, wherein the new write order for the block manipulation algorithm significantly reduces a tear effect in the graphic of the second type orientation.

20. The system of claim 13, wherein the new write order for the block manipulation algorithm comprises:
if a vertical trace of a target display device scans the complete target display device following a first order, writing the graphic of the second type pixel-by-pixel starting at the third predetermined location ending at the fourth predetermined location following the first order; and
if a vertical trace of a target display device scans the target display device in a predetermined number of horizontal bands from left to right, writing the graphic of the second type pixel-by-pixel starting at the third predetermined location ending at the fourth predetermined location in the predetermined number of horizontal bands.
